(19) United States
(12) Patent Application Publication
(10) Pub. No.: US 2010/0049557 A1
(43) Pub. Date: Feb. 25, 2010

(54) SYSTEMS AND METHODS FOR OPTIMIZING POSTAGE COSTS IN A DIRECT MARKETING CAMPAIGN

(76) Inventors: John W. Rojas, Norwalk, CT (US); George M. Macdonald, New Canaan, CT (US)

Correspondence Address: PITNEY BOWES INC., 35 WATERVIEW DRIVE, MSC 26-22, SHELTON, CT, 06484-3000, US

(21) Appl. No.: 12/195,417

(22) Filed: Aug. 21, 2008

(51) Int. Cl. G06Q 30/00

(52) U.S. Cl. 705/7; 705/14.49

(57) ABSTRACT

Systems and methods for optimizing postage costs in a direct marketing mail campaign are described. In one configuration, an efficient, advertiser-based direct mail targeting mailing list creation system is described. It may then be utilized to add names to an existing direct mail list in order to optimize postage costs associated with such a mailing campaign. In another configuration, a managed, rolling direct mail campaign is utilized to provide a standby group of mail pieces used over time to optimize postage costs associated with a first mailing campaign.

### FIELD OF THE INVENTION

The present invention relates to direct marketing campaign systems and more particularly to systems and methods for optimizing postage costs in a direct marketing campaign.

### BACKGROUND OF THE INVENTION

Many companies throughout the United States use the delivery services of the United States Postal Service (USPS) to deliver direct mail marketing materials to their customers and potential customers. Many of these companies utilize information based systems to determine a targeted mailing list of a subset of households in order to optimize a response rate for a direct mail campaign. Targeted marketing lists are typically sold through specialized brokerage houses that employ mailing list managers for developing targeted marketing lists based upon certain selected criteria. However, traditional direct mail campaign processes do not provide for an easy to use advertiser directed direct mail campaign targeted marketing list generation system.

Companies may maintain customer profile data for their customers and may have a direct marketing mailing list comprising the current and/or past customers of the company. Additionally, such companies may advertise using targeted direct mail campaigns and might then rent access to a targeted list of potential customers from a mailing list broker using selection criteria that is typically based upon block group level U.S. Census Bureau data. Such advertisers often do not receive a list of the potential customers selected, but the direct mail company addresses and finishes the direct mail pieces and inducts them with the USPS. In certain campaigns, advertisers may have access to individual profile based demographic and or psychographic targeted marketing data. Such individual profile data may be found in the advertiser's customer files or in certain circumstances may also be available from third parties subject to appropriate privacy regulations. However, traditional direct mail campaign processes do not provide for creating a targeted marketing direct mailing list by adding to a customer mailing list an efficient number of additional names selected using targeted marketing techniques to optimize postage expense.

On average, postage costs account for approximately 40% of the total cost of a direct mail marketing campaign. For certain types of such marketing campaigns, postage costs account for a much higher percentage of total marketing campaign cost. Many companies also use the USPS to deliver monthly bills, monthly statements, and annual reports for shareholders, catalogs for holiday shopping, newspapers, monthly magazine subscriptions, and Standard Mail direct mail.

The cost associated with moving mail from the sender to the recipient is related primarily to the manual effort involved. The mail must go through several sorting processes and eventually be sorted down to the carrier delivering the mail. The USPS has issued approximately 42,000 five digit zip codes in order to improve the automatic sortation and delivery of mail. If mail pieces are pre-sorted by large mailers it becomes easier for the USPS to process the mail. The USPS passes the labor savings on through “work sharing” discounts to any such mailer who pre-sorts their mail. Several other tasks may be performed to earn work sharing discounts. Mailings that meet ‘workshare’ standards qualify for discount ‘automation’ rates (5-digit/scheme, 3-digit/scheme, AADC (Automated Area Distribution Centers), Mixed AADC). For example, to qualify for the 5-digit/scheme rate, a tray with a minimum of 150 pieces must be destined to the same 5-digit zip code (e.g., 06512). Similarly, to qualify for the 3-digit/scheme rate, a tray with a minimum of 150 pieces must be destined to the same 3-digit zip code 068XX (Stamford, Conn.), 120XX (Albany, N.Y.), 19TXX (Philadelphia, Pa.), 465XX (South Bend, Ind.) and to qualify for the AADC rate a tray with a minimum of 150 pieces must be destined to the same AADC.

Additionally, under current USPS postal Regulations there are other instances where a 5 digit scheme discount may be obtained by combining zip codes in the same geographic vicinity, e.g. all the following zip codes may be combined with zip code 53707: 53708, 53774, 53777, 53778, 53779, 53782, 53783, 53784, 53785, 53786, 53788, 53789, 53790, 53791, 53792, 53793, and 53794 to obtain the 5-digit/scheme rate. To qualify for mixed AADC all remaining pieces placed in trays are required to be mixed AADC. Consequently, mailers use file-based presort software and/or physical presort to maximize their mailings 5-digit sortation densities for workshare discounts. Furthermore, these mailers are producing and inducting large volumes of mail several days a month or even daily as it is the case for large billers (e.g., credit card billers). However, although they are sending large volumes of mail to the same 5-digit/scheme (throughout the month), they usually cannot take advantage of 5-digit/scheme rates because they do not meet the minimum required pieces per tray on a given day. This problem is costing large mailers a significant amount of money.

For example, a large credit card biller with monthly volumes close to 18 million mail pieces has only a natural 5-digit/scheme sortation density of about 26% since they are producing and sending their bills according to their customers billing cycles and payment due dates. A disadvantage of the prior art is that many large mailers were not able to take advantage of postal discounts. A further disadvantage of the prior art is that some times large mailers just fall short by a few mail pieces of filling a portion of a tray or container able to take advantage of higher postal discounts. Additionally, despite the poor sortation density, traditional direct mail campaign processes do not provide for creating a targeted marketing direct mailing list by adding to another outgoing mailing in order to optimize postage expense. Moreover, traditional direct mail campaign processes do not provide for modified direct mail USPS induction based upon environmental data such as weather forecast data.

Accordingly, there are several disadvantages of currently available systems and methods for creating direct marketing campaigns including.

### SUMMARY

The illustrative embodiments of the present application describe direct to direct marketing campaign systems and more particularly to systems and methods for optimizing postage costs in a direct marketing campaign.

In one illustrative configuration, systems and methods for providing an easy to use advertiser directed direct mail campaign targeted marketing list generation system are described. An advertiser selects certain targeting marketing criteria including at least one geographic parameter such a campaign radius. A map is then generated for the advertiser using the targeted marketing criteria with targeted marketing data such as block group level demographic data, individual demographic/psychographic and/or individual profile history data. The map is displayed according to geographic boundaries of the data such as block group boundaries with a visual indication of a proposed campaign parameter such as potential target opportunity: high (>5000), medium or low (<1000). The advertiser may then use the map and computer graphical user interface to select a block group for inclusion into the targeted marketing list. A percentage slider may also be used to select a percentage of the potential customers in the block group such as a random selection.

In another illustrative configuration, systems and methods for providing for creating a targeted marketing direct mailing list by adding to a first proposed customer mailing list an efficient number of additional names selected using targeted marketing techniques to optimize postage expense are described. A first proposed direct mail campaign mailing list is created such as by using a graphical user interface. Thereafter, the advertiser is presented with an offer to optimize postage costs such as by increasing the number of mailings in certain zip codes in order to reduce the average postage cost per direct mail piece. In an alternative, an initial advertiser internal mailing list establishes a baseline mailing list (transaction mail and/or direct advertising mail) and additional potential customer names are selected for addition in certain zip codes in order to reduce the average postage cost per direct mail piece.

In yet another illustrative embodiment, systems and methods directed to providing for creating a rolling targeted marketing direct mailing list by adding to other outgoing mailings in order to optimize postage expense are described. For example, in a single user embodiment, a large credit card company may have certain transactional mailings that are to be inducted each day of the month directed toward recipients in several zip codes. The credit card company may also desire to send a targeted direct mail campaign to recipients in the same zip codes. The described systems are used to generate a targeted direct mail list in the zip codes and an associated mailing campaign design that may be used in a type of standby induction mode. A standby period is defined for the targeted marketing list. Each day, if the transactional mailing in a particular zip code is not optimized for postage costs, such as including less than 150 pieces, the required number of direct mail pieces to optimize postage costs are finished and added to the transactional mailing. At the end of the standby period, all of the remaining direct mail pieces are inducted. The systems described manage the rolling direct mail campaign such as by tracking which pieces were sent. Additionally, the standby mail does not have to have a delivery class initially assigned. A delivery class may be selected when the standby mail is to be used in a postage optimization. In alternatives, a multi-user system may be employed wherein standby mailing space is brokered by a third party such as a trusted third party direct mail campaign provider. A primary mailing campaign is processed by a presort house that offers standby mail costs to third parties based upon targeted marketing criteria.

In yet another illustrative embodiment, systems and methods directed to providing for modified the USPS induction of a mailing such as a direct mail campaign mailing based upon environmental data such as weather forecast data are described. The systems described utilize weather forecast data on a individual zip code basis to determine whether to induct the associated portions of a mailing campaign. For example, with reference to a direct advertising mail campaign, certain mail pieces may have a low tolerance for moisture. Accordingly, if a 5-day weather forecast predicts likely rain, the induction of those direct mail pieces is delayed. Additionally, customized mail pieces may be used as described and referred to herein. For example, if the advertiser is advertising pool supplies, she might direct the system to induct only if 3-day weather forecast is 80 degrees F. or above. Furthermore, in embodiments having day of week delivery prediction, the forecast is for the estimated day of delivery, not the date of induction. Several additional illustrative configurations are described below.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic diagram of a customized direct mail creation and distribution system according to an embodiment of the present application.

FIG. 2 is a schematic view of a targeted direct mail campaign potential customer list creation system user interface according to an embodiment of the present application.

FIG. 3 is a schematic view of a targeted direct mail campaign potential customer list creation system user interface for optimizing postage costs according to an embodiment of the present application.

FIG. 4 is a graph of the number of mail pieces sent each day during a month to a particular zip code after optimizing the mailings for postage costs according to an embodiment of the present application.

FIG. 5 is a graph of the number of mail pieces sent each day during a month to a particular zip code after adjusting certain mail induction dates based upon environmental data according to an embodiment of the present application.

FIG. 6 is a flowchart showing an illustrative process for generating an advertiser directed direct mail campaign targeted marketing list according to an illustrative embodiment of the present application.

FIG. 7 is a flowchart showing an illustrative process for creating a targeted marketing direct mailing list by adding to a first proposed customer mailing list an efficient number of additional names selected using targeted marketing techniques to optimize postage expense according to an illustrative embodiment of the present application.

FIG. 8 is a flowchart showing an illustrative process for creating a targeted marketing direct mailing list by adding to other outgoing mailings in order to optimize postage expense according to an illustrative embodiment of the present application.

FIG. 9 is a flowchart showing an illustrative process for modifying the USPS induction of a mailing based upon environmental data such as weather forecast data according to an illustrative embodiment of the present application.

### DETAILED DESCRIPTION

The illustrative embodiments of the present application describe direct marketing campaign systems and methods and in certain embodiments describe systems and methods for optimizing postage costs in a direct marketing campaign. The illustrative embodiments of the present application are provided to describe illustrative systems and methods that address needs in the marketplace including but not limited to systems and methods directed to graphical user interface systems for mailing list creation, systems and methods directed to optimizing postage costs in a direct mail marketing campaign by increasing postal discounts, systems and methods directed to optimizing postage discounts in several mailings by creating a rolling direct mail targeted marketing campaign combined with other mailings and systems and methods for modifying the USPS induction of a mailing using environmental data such as weather forecast data. The illustrative embodiments are described with reference to direct mail pieces comprising postcards, but other direct mail pieces including letters, catalogs, and brochures may be utilized. Similarly, the physical delivery systems described in the embodiments herein comprise the United States Postal service (USPS) delivery system, but other physical delivery systems may be utilized in conjunction with or as an alternative to the USPS.

The current 1 ounce first class postage rate is $0.41. TABLE 1 below shows the current work share discount rates applicable to properly sorted and processed mail pieces that meat the USPS requirements. The USPS requires that the mail meets certain conditions to be eligible for the discounts. For example, a mailing must include at least 150 pieces per tray in a 5-digit zip code presort.

TABLE 1

| Automation | 1 oz. 1^{st} class | 1^{st} class 4 × 6 postcard |
|---|---|---|
| None, presort | $0.394 | $0.242 |
| Mixed AADC | $0.369 | $0.223 |
| AADC | $0.351 | $0.213 |
| 3-digit | $0.346 | $0.210 |
| 5-digit | $0.324 | $0.199 |

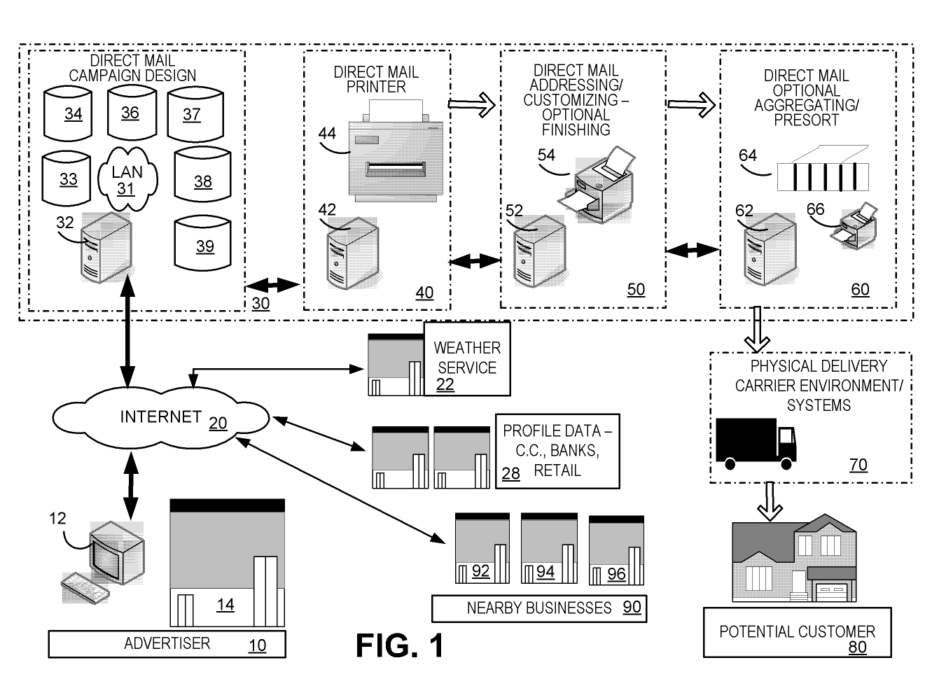

Referring to FIG. 1, a schematic diagram of a customized direct mail creation and distribution system according to an embodiment of the present application is shown. An advertiser 10 comprises a small local business such as a retailer having a single retail location 14 and a computing system 12 such as a DELL PRECISION M6300 connected to the Internet 20. In alternative embodiments, the advertiser includes a national or regional business having many locations and computing systems and also a national or regional franchise having many locations. A direct mail piece campaign company utilizes a direct mail campaign system that includes a direct mail design system 30, a direct mail printing system 40, a direct mail addressing/customizing and optional finishing system 50 and a direct mail aggregating and presort system 60. The systems in the illustrative embodiment are integrated in a system connected to the Internet 20. However, as will be appreciated with reference to the description herein, some or all of systems 40, 50 and 60 may be operated by other partner companies. Moreover, a large advertiser may comprise any or all of systems 30, 40, 50 and 60 in a captive in-house operation.

The direct mail piece campaign design service includes system 30 having a local area network 31 connected to the Internet 20. Server 32 provides a campaign design service accessible using the Internet 20 and a browser interface. Alternatively, the campaign design service processes described herein may be provided using a heavy client interface. A first database available on LAN 31 is a campaign data and billing database 33 that stores information related to the individual campaigns and any effectiveness tracking. The system is configured to design, manage and track rolling direct mail advertising campaigns that are added to outgoing mailings on an as needed basis during a “standby” period.

A second database available on LAN 31 is a block group level demographic and psychographic database 34 having data available from the U.S. Census Bureau and private data sources. A third database available on LAN 31 is a location intelligence database 36 including map data and automobile traffic data. A fourth database available on LAN 31 is an individual profile database 37 including a current customer list with addresses and optionally profile data for each registered advertiser 10. The individual profile data in database 37 may also include individual data from nearby businesses 92, 94, 96 if privacy regulations permit. Database 37 may also include individual data received from large businesses 28 such as credit card companies, banks and retail businesses if and to the extent privacy regulations permit such use. A fifth database available on LAN 31 is an advertising design database 38 that includes templates and individual designs used in a particular direct mail campaign. The sixth database is the customization database 39 and includes the customization data and tables used to apply the customization algorithms such as weather forecast modifications of USPS induction dates as described herein. Illustrative data included in the tables is described herein with reference to the illustrative embodiments using the data.

The Server 32 includes a DELL POWEREDGE M1000E server, but other servers such as a SUN T5240 server may be used including geographically dispersed servers. Servers 42, 52 and 62 may also comprise DELL POWEREDGE M1000E servers connected to the Internet 20. The databases are configured using an available relational database such as ORACLE 12i or MICROSOFT SQL server. Moreover, any or all of databases 33, 34, 36, 37, 38 and 39 may be resident in a single server or may be geographically distributed. They may be retrieved in real time or near real time using networking such as web services connected to third party data providers. Many alternative configurations may be used including multiple servers and databases including a geographically distributed system. The processes described herein may be implemented in C++ on a MICROSOFT WINDOWS XP platform and utilize the MICROSOFT SHAREPOINT content management system with “dot net” programs. Alternatively, PHP code may be used with open source systems such as the JOOMLA content management system and APACHE web server with MYSQL databases. The data sources such as weather forecast data may be accessed using their standard web services APIs. Systems 92, 94, 96, 28 and 22 are also accessible using secure connections over the Internet 20 or other suitable communications network. An environmental data resource 22 is also available to server 32 using a communications channel such as the Internet 20. For example, the U.S. National Digital Forecast Database (NDFD) is made available to the public and commercial enterprises by the U.S. National Weather Service's (NWS) digital forecast database. This service provides a web service using a Simple Object Access Protocol (SOAP) server and extensible markup language (XML) formatted data.

At least one direct mail printer 40 may be utilized having a computing system 42 and at least one high speed industrial printer 44. The Direct Mail Campaign creation system server 32 may be connected to the direct mail printer 40 by LAN 31 or other appropriate connection. The direct mail pieces may be printed in template form using printer 44 or may alternatively be printed individually such that the customization is provide per direct mail piece using printer 44. Direct mail addressing/customizing/finishing system 50 is also connected to LAN 31 using computing system 52. A second printing process using printer 54 includes a dedicated address printer that is also utilized to print a customized portion of the direct mail piece. Aggregating/pre-sort system 60 includes server 62 and a sorting system 64 connected to LAN 31. In embodiments using just-in-time printed mail pieces, the systems and methods herein may be used to create customized direct mail pieces using printer 66. Additionally, if a single aggregated direct mail printing is desired, the embodiment may further include the systems and methods of commonly owned, co-pending U.S. patent application Ser. No. 09/898,232, filed Jul. 2, 2001 by Joshi, et al., the application hereby incorporated by reference in its entirety.

The finished and optionally pre-sorted direct mail pieces are then physically inducted into the USPS systems 70. The direct mail pieces may be inducted at any particular induction point that is convenient to the last processing step or may be inducted at a regional or local postal service location with respect to a group of direct mail pieces. The USPS then delivers the direct mail pieces to the potential customers 80.

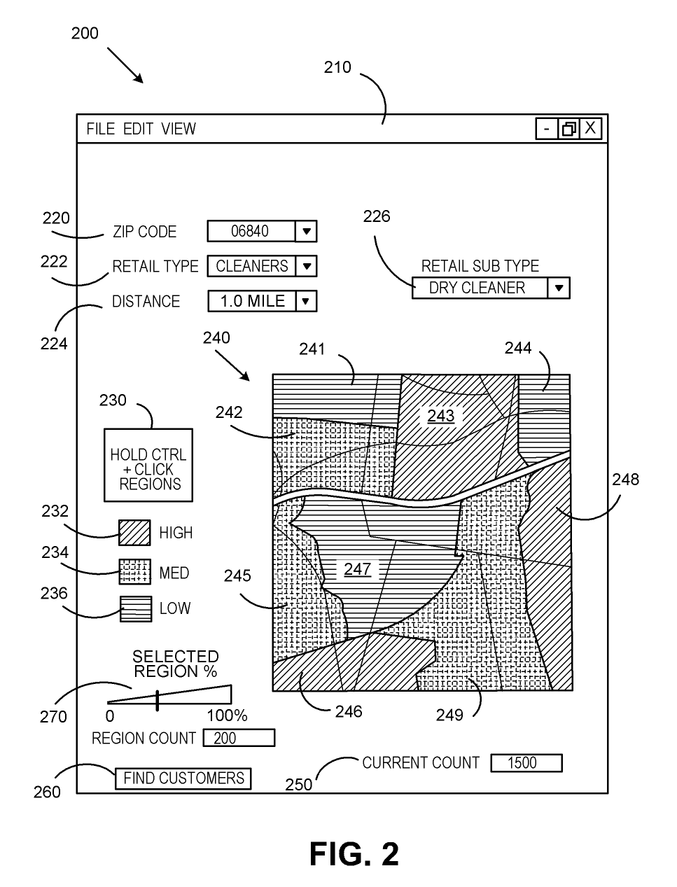

Referring to FIG. 2, a schematic view of a targeted direct mail campaign potential customer list creation system user interface 200 according to an embodiment of the present application is shown. The targeted list creation system uses a server 32 to communicate with advertiser 12 through an Internet World Wide Web browser interface 210. Alternatively, a heavy client program may be utilized on advertiser system 12. In the illustrative embodiment, browser window 210 includes several user interface controls. Several selection sections allow the advertiser to select targeting criteria. Several types of targeting systems are known and may be utilized. The targeting criteria may be configured to operate on aggregated block group demographic/psychographic data or more specific data such as individual profile data that may be available through the advertiser's customer database or other third party profile data provider.

The advertiser 10 comprises a small dry cleaning business in the illustrative example. The advertiser logs into the targeted marketing system 30 through the Internet 20 to server 32. The server 32 authenticates the user and then creates web page 210 that is sent to the advertiser's browser on system 12. The advertiser then selects the appropriate zip code 220 from a selection box or alternatively is provide a text entry box so that the zip code may be typed in. The advertiser 12 picks a business type 222 and sub-type 226 followed by a targeted marketing radius 224. The business type selections 222, 226 are used to generate the targeted marketing list according to predefined search criteria assigned to those types by system 30. In an alternative, other targeted marketing criteria are utilized such as those described and referred to in commonly-owned, co-pending U.S. patent application Ser. No. ______, entitled “Systems And Methods For Customizing Direct Marketing Mail Pieces”, filed on even date herewith by Roj as, et al. (attorney docket G-430), the application incorporated by reference herein in its entirety.

Browser interface 210 includes instructions 230 for using the point and click graphical user interface mailing list generation system and a legend for marketing effectiveness. The legends include high potential areas 232, medium 234 and low 236. The server 32 uses the targeted marketing campaign inputs 220, 222, 226 and 224 to generate a map 240 including targeted regions. Here, the targeted marketing utilized block group data and the regions shown correspond to U.S. Census Bureau defined block group boundaries. 9 block groups are displayed and have varying levels of estimated targeted marketing effectiveness based upon the targeted marketing campaign inputs. The advertiser may then select any of the block groups 241, 242, 243, 244, 245, 246, 247, 248 and 249. When the advertiser 10 selects high potential block group 342, the region selector 270 displays 100% and a total count for the region. The advertise may then use slider interface 270 to reduce the percentage of names in the targeted mailing list based upon the advertiser's desire to target the particular geographic area selected. A current count holder 250 displays the total count selected. The graphical user interface highlights the selected area and displays the selected percentage inside the region display on map 240. The user may then select another region and repeat the process of selection. Thereafter, the advertiser may select find customers to finalize the selections for targeted marketing mailing list generation. Here, the advertiser does not receive access to the mailing list names, but direct mail campaign system 30 is used to produce the mailing campaign using a selected template such as those described in the application entitled Systems and Methods for Customizing Direct Marketing Mail Pieces incorporated above.

An illustrative marketing campaign database table used to provide the back-end targeting intelligence for the dry cleaning business selected is shown in TABLE 2 below.

TABLE 2

| Advertiser | NAICS | Aggregate Demographic | Individual Profile |
|---|---|---|---|
| Dry | 812310 | 75% Men 25-45 > 20% | 90% purchase dry clean |
| Cleaner | | 75% Income > $100k | 50% Income > $100k |
| Hardware | 444130 | 75% Men 25-45 > 20% | 75% purchased HW |
| | | 15% Income < $100k | 75% Men 25-45 |
| Coffee | 722213 | 60% Men 45-65 > 20% | 50% purchased coffee |
| | | 50% Income > $80k | 60% Men 45-65 |
| . . . | . . . | . . . | . . . |

Targeted marketing techniques are known and the above table is illustrative to show how the system of FIG. 2 may populate map 240 with only the data provided by the advertiser. Alternatively, SIC data may be used and the advertiser target criteria may utilize regional templates and be customizable by the advertiser.

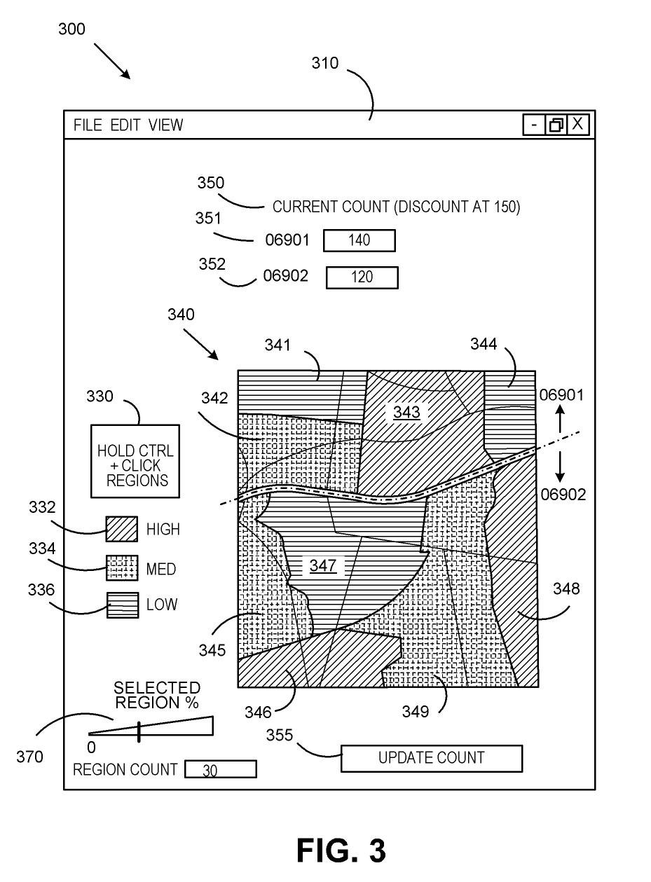

Referring to FIG. 3, a schematic view of a targeted direct mail campaign potential customer list creation system user interface 300 for optimizing postage costs according to an embodiment of the present application is shown. In a similar manner as described above, server 32 creates a web page 310 for an advertiser 10 using a browser interface on system T2. A current count 350 is displayed showing at least one zip code 351, 352 and associated counts. The map 340 is modified to include zip code boundary information that shows the boundary between zip codes 06901 and zip code 06902. Similar instructions are provided 330, 332, 334, 336 and the advertiser may select any of the block groups 341, 342, 343, 344, 345, 346, 347, 348 and 349. The advertiser may wish to add 10 mail pieces to zip code 06901 and may select medium potential area 342. The advertiser may then manipulate slider interface 370 to achieve an updated count of at least 150 in zip code 06901 351. When completed, the advertiser 10 selects update count 355.

In one alternative, a primary or original mailing campaign comprises the advertiser's customer list. As an illustrative example, the original mailing campaign has 140 recipients in zip code 06901 and 120 recipients in zip code 07001 (changed from 06902 for illustrative purposes). In actual use, systems according to the teachings herein may use significantly larger numbers of zip code and as such the geographies may be grouped in regions such as by county or state. Here, we assume a I ounce, first class direct mailing using the system of FIG. 3. The user interface of FIG. 3 provides a postage cost for the current customer mailing list campaign, e.g., near 350 a current cost of $102.44 assuming a presort process was applied but there is no 3 digit zip available for the two zip codes. The user is then provided an advertising “up-sell” offer to add 10 recipients in zip code 06901 and 30 recipients in zip code 070001 using the dry cleaning targeted marketing list and a random selection of names in the sub-regions selected by the advertiser using the map 340. Here the postage is $97.20 and represents an overall postage savings for 40 more direct mail pieces, although there would be a cost for the mail pieces that may also be displayed near 350 and/or aggregated with the postage costs. If the direct mail piece costs $0.50 without postage, the customer list only offer costs $130 mail pieces+$102.44 for postage or $232.44 for 260 mail pieces. The modified offer costs $150 mail pieces+$97.20 postage or only $247.20 for 300 mail pieces after optimizing postage costs. The per-mail-piece costs may also be calculated and displayed near item 350 and the per mail piece cost for the up-sell mail pieces is calculated and displayed near 350 as $247.20-$232.44/40 or only $0.37 per mail piece including the cost of the mail piece and postage. As an added incentive, the advertising system 32 may offer the advertiser a rolling up-sell where 1000 or more names of non-customers are selected using the embodiments herein. The system then tracks which names are used in successive mailings to the advertiser customer list plus up-sell. Here, the first 40 names are used in the first advertiser customer list mailing and assuming the customer list stays static, another 40 different names would then be selected for the subsequent mailings until the list is exhausted. The advertiser may be charged for the up-sell mailing list names when purchased or on an as used basis. Additionally, the up-sell direct mail piece response rate may be separately tracked to determine the effectiveness of the program.

The single user, primary customer list with secondary up-sell with tracking may use a database table in database 31 as shown in TABLE 3 below. Here the same customer is used for the up-sell and a standby up-sell.

TABLE 3

| Customer | Campaign | Design | Up-sell | Names | Zip | date |
|---|---|---|---|---|---|---|
| 000001 | 0000001 | 000001 | 000001 | 1-62 | 06902 | Aug. 04 |
| | | | | | | 2008 |
| 000001 | 0000001 | 000001 | 000001 | 63-83 | 06902 | Aug. 05 |
| | | | | | | 2008 |
| 000001 | 0000001 | 000001 | 000001 | 84-124 | 06902 | Aug. 06 |
| | | | | | | 2008 |
| 000001 | 0000001 | 000001 | 000001 | 125-150 | 06902 | Aug. 07 |
| | | | | | | 2008 |
| . . . | . . . | . . . | . . . | | . . . | |

Here, customer 000001 in campaign 000001 is using design 000001 that is may be customized as described and referred to herein. The customer has purchased or implemented in-house a 1000 name standby direct mail up-sell in zip code 06902 using the system of FIG. 3. The up-sell direct mail pieces may also be separately tracked for response in another database table.

In another alternative, the system 32 provides an “up-sell” offer to the advertiser to round up each zip code in a targeted direct mail campaign to an optimal postage level such as the 150 piece level currently required to achieve a 5-digit presort discount without graphical user interface map selections. The server 32 provides an initial cost value with price per mail piece and then a suggested larger mail campaign list with revised cost and price per mail piece data taking into account the postage cost optimization. In such a system, the zip codes need not be displayed, particularly for a national advertising campaign having tens of thousands of zip codes. The direct mail campaign postage optimization is provided using total or regional aggregate before and after data for the potential “up-sell” offer. The “up-sell” direct mail pieces may also be separately marked and/or tracked so that system 32 may separately track how effective the original mailing list is compared to the direct mail pieces suggested during the revision.

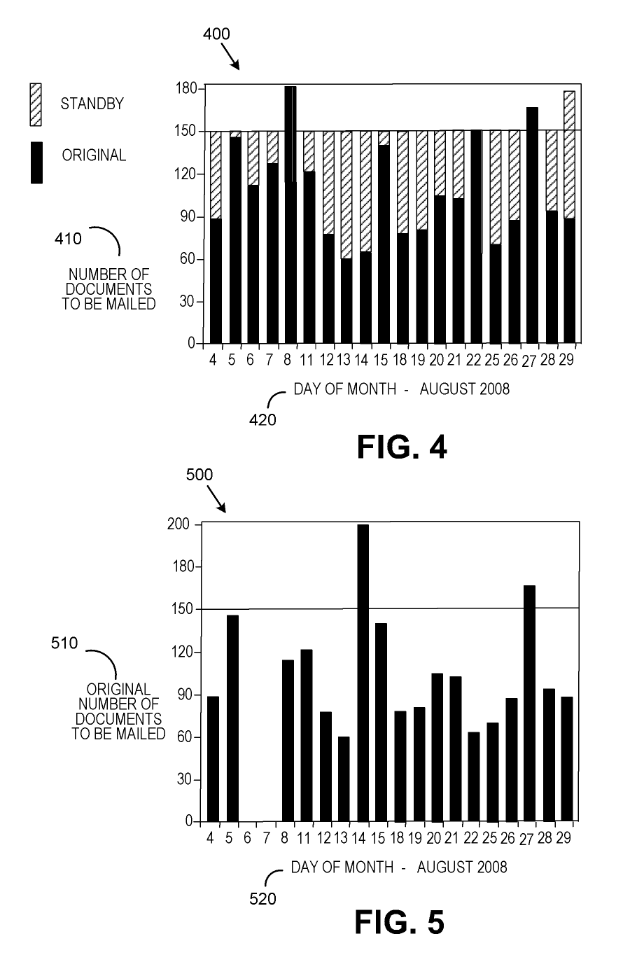

Referring to FIG. 4, a graph 400 of the number of mail pieces sent each day during a month to a particular zip code after optimizing the mailings for postage costs according to an embodiment of the present application is shown. For each day of the month 420, an original number of documents to be mailed 410 are shown in solid as a so called primary mailing. As described herein, a standby mailing list is created using system 32 and then utilized to optimize postage discounts by adding standby direct mail pieces to a first mailing during a standby period. Here, the standby direct mail pieces are shown with a pattern. The primary mailing may be a type of transaction mail such as credit card statements or some other mailing or groups of mailings having a similar pattern.

An advertiser 10 may have transaction mailings such as billing mailings that are sent each business day of the week such as credit card statements shown as solid bars. A 5-digit presort bin requires a minimum of 150 pieces, but the transactions mailings do not usually have the required number. When needed to fill a 5-digit sort bin, the required number of standby postcards or advertising letters are addressed and customized such as by using weather data and printer 66 with information from server 32. A standby direct mail list may be exhausted over time as space opens up in each 5-digit bin by maintaining records of the addresses used to date. The customization may change for each batch for example if the weather forecast changes. Alternatively, printer 66 may print the entire direct mail piece on demand when needed to fill a sort bin. Accordingly, customization and tracking of the standby direct mail pieces is performed on a rolling basis as needed.

For example, in this single user system, a direct mail advertiser 10 may purchase the service or implement in-house and buy access to a mailing list including 1000 names in a particular zip code such as 08460. If a third party is performing the service of at least addressing and induction, the advertiser 10 may use the system without even knowing the identity of the potential customers. The advertiser wishes to reduce postage costs and instructs the direct mail company to hold the mail pieces on standby for up to four weeks using a defined weather forecast based customization. In the first week of the month, a 06840 bin with only 90 pieces is available. Direct mail company server 32 randomly selects 60 names from the 1000 name list and marks them as used. While the advertiser could normally add all of its mail pieces to the first bin at the discounted price, the direct mail company wishes to have additional mail pieces in standby mode in order to fill more bins to the minimum 5-digit sort capacity of 150 pieces. Accordingly, the direct mail company provides appropriate financial incentive for using the standby mode. On the last business day of the fourth week, no standby mail pieces are required, but the standby period is exhausted. Because the standby period is exhausted, the remaining direct mail pieces are customized using the weather forecast for week 4 and inducted on the last business day of week 4. Database table similar to TABLE 3 above may be utilized.

In a multi-user system, the tables track standby mail piece use by primary mailing customer and also by standby customer. The multi-user, standby customer table may use a database table in database 31 as shown in TABLE 4 below. A separate table by primary customer is also provided to show that standby campaigns that were matched up with a particular primary mailing.

TABLE 4

| | Standby | | | | | |
|---|---|---|---|---|---|---|
| Customer | Campaign | Design | expires | Names | Zip | date |
| 000001 | 0000001 | 000001 | Aug. 07 | 1-62 | 06902 | Aug. 04 |
| | | | 2008 | | | 2008 |
| 000001 | 0000001 | 000001 | Aug. 07 | 63-83 | 06902 | Aug. 05 |
| | | | 2008 | | | 2008 |
| 000001 | 0000001 | 000001 | Aug. 07 | 84-124 | 06902 | Aug. 06 |
| | | | 2008 | | | 2008 |
| 000001 | 0000001 | 000001 | Aug. 07 | 125-500 | 06902 | Aug. 07 |
| | | | 2008 | | | 2008 |

Here the standby customer order expires August 7 and the mail pieces left are mailed then. Thereafter, standby order 00002 begins with the need as shown in FIG. 4. System 32 may use multiple standby direct mail customers to optimize postage discounts related to a single primary mailing. For example, if the primary mailing is national, system 32 may solicit standby direct mail as described herein based upon a demographic or similar targeted analysis of the zip codes used in the primary mailing. The savings may be split as between the primary mailing customer, the standby mailers and the processor as market conditions dictate. The savings and financial data may also be stored in appropriate transaction related tables by system 32.

Referring to FIG. 5, a graph 500 of the number of mail pieces sent each day during a month to a particular zip code after adjusting certain mail induction dates based upon environmental data according to an embodiment of the present application. Here, the mailing dates 520 and number of documents to be mailed 510 are graphed. System 32 utilizes a weather forecast and mailing campaign profile information to determine whether to delay a particular mailing. Here, the mail pieces shown are the same volume as the transaction mailings originally shown in FIG. 4. The direct mail campaign profile data suggests that the direct mail should not be sent when it may be raining. Here rain is expected on the 13^{th} and the expected delivery time is 5 days. Accordingly, the mail pieces originally scheduled for induction on August 6^{th} and 7^{th} are delayed until August 14^{th}.

Additionally, customized mail pieces may be used as described and referred to herein. If a Men's store advertises nationally, the weather based mail induction may be based upon the weather forecast and may also include a weather based customization offer. For example, an umbrella offer may arrive before expected rain and a swimwear offer after 100 degree heat. As another example, if the advertiser is advertising pool supplies, she might direct the system to induct only if 3-day weather forecast is 80 degrees F. or above. Furthermore, in embodiments having day of week delivery prediction, the forecast is for the estimated day of delivery, not the date of induction. Systems for estimating delivery times described and referred to herein may be used to more accurately time induction based upon weather forecasts.

An example database table that may be used in a weather based induction and customization direct mail system is shown below in TABLE 5.

TABLE 5

| Cus- | | | | | Cus- | |
|---|---|---|---|---|---|---|
| tomer | Campaign | ZIP | Weather | Test | tomization | Deliver |
| 000001 | 0000001 | 06840 | Week32 | default | no | Event |
| | | | | | | +2 |
| 000001 | 0000001 | 06840 | Week32 | Rain | Rain1 | Event |
| | | | | | | −1 |
| 000001 | 0000001 | 94025 | Week32 | default | no | Event |
| | | | | | | +2 |
| 000001 | 0000001 | 94025 | Week32 | >100 | HOT1 | Event |
| | | | | | | +2 |
| . . . | . . . | | . . . | . . . | . . . | |

Here, customer 000001 in campaign 000001 is using design 000001 that is customized and weather times by zip code. The campaign is set to be processed in week 32. In zip code 06840, unless there is rain, the campaign goes out targeting delivery 2 days after week 32 starts. If there is rain in the forecast that week, the target is one day before the rain. Similarly, in zip code 94025 a different test is used as shown above.

In another alternative, a direct mailing list may be graphically selected using a map with weather forecast data displayed along with an optional calculation of estimated delivery time. The delivery estimate and weather forecast may also be combined into a single time from event metric. Additionally, targeting data such as demographic, psychographic and/or individual potential customer data may be displayed and/or used in a background targeted marketing list selection. For example, if the targeted marketing campaign involves an advertiser having a dry cleaning business with multiple locations, a map of the relevant locations may be displayed. If the advertiser believes the direct mail should arrive 1 day after a rain storm, the rain forecast may be displayed. The advertiser may then use the modified graphical user interface of FIG. 2 including sliders, etc., to include weather forecast selection using geographic information such as block group and/or zip code boundaries to create a mailing that will arrive I day after a rain storm. As can be appreciated, the background demographic/psychographic targeting may be used on an aggregate block group level or at the individual level for current customers or using third party data under appropriate privacy constraints such as through the use of a trusted third party.

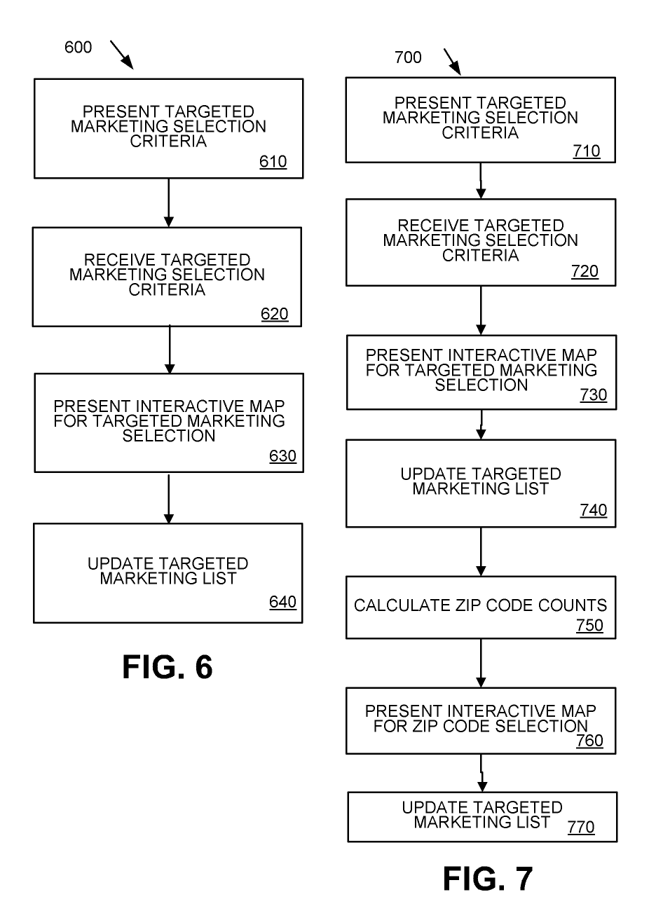

Referring to FIG. 6, a flowchart showing an illustrative process 600 for generating an advertiser directed direct mail campaign targeted marketing list according to an illustrative embodiment of the present application is shown. In step 610, the server present a graphical targeted marketing criteria selection screen. In step 620, the server receives the targeted marketing criteria selection data. In step 630, the server generates an interactive map used for targeted marketing list selection. In step 640, the server updates the targeted marketing list based upon the map section inputs. The process is to be understood with reference to and as including the system and mail piece figures and text described and referred to herein.

Referring to FIG. 7, a flowchart showing an illustrative process 700 for creating a targeted marketing direct mailing list by adding to a first proposed customer mailing list an efficient number of additional names selected using targeted marketing techniques to optimize postage expense according to an illustrative embodiment of the present application is shown. In step 710, the server present a graphical targeted marketing criteria selection screen. In step 720, the server receives the targeted marketing criteria selection data. In step 730, the server generates an interactive map used for targeted marketing list selection. In step 740, the server updates the targeted marketing list based upon the map section inputs. In step 750, the server calculates a mail piece count by zip code and displays the count and discount information to the advertiser. In step 760, the server receives additional selection information. In step 770, the server updates the targeted marketing list again. In an alternative, the server 32 calculates a revised targeted marketing list based upon postage discount information and provides the revised offer to the advertiser. The process is to be understood with reference to and as including the system and mail piece figures and text described and referred to herein.

An illustrative method for creating a direct mail advertising campaign targeted mailing list includes prompting an advertiser for targeted mail campaign information; receiving targeted mail campaign information from the advertiser; providing a graphical representation of potential targeted regions each having a potential opportunity indication; receiving selection information from the user interacting with the graphical representation; and creating the direct mail advertising campaign targeted mailing list using the selection information. The method may also include determining an alternative targeted mail campaign information to optimize postage costs; and providing the alternative targeted mail campaign information to the advertiser. The alternative targeted mail campaign information may include a direct mail piece up-sell offer based upon optimized postage costs and the direct mail piece up-sell offer is provided graphically by zip code. Additionally, the direct mail piece up-sell offer is provided on a rolling basis over multiple primary mailings. The direct mail advertising campaign targeted mailing list is created using the selection information and profile data selected from the group consisting of aggregated block group targeting data and individual profile data. Furthermore, the direct mail advertising campaign comprises a primary direct mail advertising campaign and a secondary direct mail advertising campaign.

As described herein, the primary direct mail advertising campaign comprises a current customer list and the secondary direct mail advertising campaign comprises a targeted mailing list is created using the selection information and profile data selected from the group consisting of aggregated block group targeting data and individual profile data.

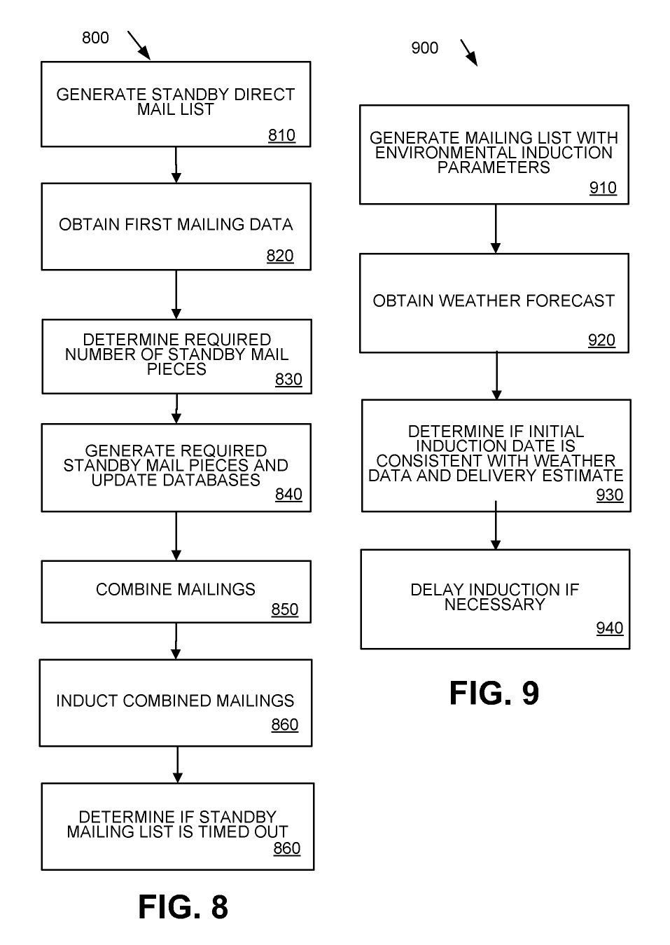

Referring to FIG. 8, a flowchart showing an illustrative process 800 for creating a targeted marketing direct mailing list by adding to other outgoing mailings in order to optimize postage expense according to an illustrative embodiment of the present application is shown. In step 810, the server 32 generates a standby targeted marketing list for at least one zip code having standby parameters including the last standby date. In step 820, the server receives a first mailing count per zip code on a particular day. In step 830, the system determines a required number of standby mail pieces per zip code. For example, if the first mailing includes 90 mail pieces on Aug. 4, 2008 in zip code 08640, the system would generate 60 standby mail pieces. In step 840, the system generates the required standby mail pieces, optionally customizes them and updates the standby direct mailing campaign records to reflect the names used from the list and the day used. In step 850, the system combines the first mailings and the required standby mail pieces. In step 860, the system inducts the combined mail pieces. In step 870, the system determines if the standby list has timed out, and if so, inducts the remaining standby pieces. The process is to be understood with reference to and as including the system and mail piece figures and text described and referred to herein.

An illustrative method for optimizing postage costs in a direct mail campaign includes obtaining a standby direct mail campaign having an associated tracking database; receiving a primary mailing; determining a number of standby mail pieces required to optimize postage costs associated with the primary mailing; adding the required number of standby mail pieces to the primary mailing; and updating the tracking database to reflect the standby mail pieces used. The method may also include utilizing a plurality of standby direct mail campaigns to optimize postage costs associated with a primary mailing. The primary mailing may include sub-mailings by geography and include determining an appropriate one of the plurality of standby direct mail campaigns to optimize postage costs associated with each sub-mailing in the primary mailing using targeted marketing criteria. Similarly, the primary mailing may include sub-mailings by day and further include determining an appropriate one of the plurality of standby direct mail campaigns to optimize postage costs associated with each sub-mailing in the primary mailing using date availability. If so, it may include determining if the appropriate one of the standby direct mail campaigns is expired; and if expired, adding any remaining mail pieces in the appropriate one of the standby direct mail campaigns on the expiration day.

Since the system may utilize more than one standby direct mail campaign to optimize postage costs associated with a primary campaign and the direct mail campaigns, the process may include at least two of the plurality of standby direct mail campaigns associated with at least two distinct respective standby advertisers. Moreover, the process may include customizing the standby mail pieces when used as described and referred to herein.

Referring to FIG. 9, a flowchart showing an illustrative process 900 for modifying the USPS induction of a mailing based upon environmental data such as weather forecast data according to an illustrative embodiment of the present application is shown. In step 910, the server generates a mailing campaign list having an initial induction date and environmental induction parameters such as rain restrictions. In step 920, the server obtains weather forecast data by zip code and makes a delivery date estimate determination by destination zip code. In step 930, the server determines whether the mailing campaign initial induction date conflicts with the weather data and delivery estimate. In step 940, the server delays the induction date if necessary based upon the weather parameters. The process is to be understood with reference to and as including the system and mail piece figures and text described and referred to herein.

An illustrative method for determining when to induct a mail piece includes obtaining a mail campaign profile comprising at least one environmental data related induction parameter associated with at least one environmental parameter for the mail campaign; obtaining an environmental data forecast; determining whether the at lease one environmental data related induction decision is applicable for the mail piece using the campaign profile and the environmental data forecast; and inducting the mail piece in accordance with the determination. The environmental data may include weather data and the environmental data forecast may include a weather forecast. Moreover, the mail piece may be a direct mail piece and the at least one environmental parameter may be a preferred delivery date. The direct mail piece may be customized based upon the weather forecast. Additionally, the process may use a mail campaign having at least two sub-mailings each associated with a distinct destination zip code and the environmental forecast includes a sub-forecast obtained for each distinct destination zip code, wherein the process further includes separately determining for each sub-mailing whether the at lease one environmental data related induction decision is applicable for each of the plurality of mail pieces using the campaign profile and the sub-forecast.

In an alternative applicable to any of the embodiments herein, the systems and methods described herein may utilize the customized direct marketing mail pieces described in commonly-owned, co-pending U.S. patent application Ser. No. ______, entitled “Systems And Methods For Customizing Direct Marketing Mail Pieces”, filed on even date herewith by Rojas, et al. (attorney docket G-430), the application incorporated by reference herein in its entirety. For example, with reference to FIG. 4, if standby mail pieces are desired, a pre-printed batch of postcards may be provided to the direct mail company 30 and then customized as needed in standby mode. Moreover, with reference to FIG. 5, if weather forecast based delivery is utilized, the corresponding customized direct mail pieces may be utilized when customized for each destination sip code.

In further alternative embodiments, the embodiments described herein may additionally and/or alternatively utilize the systems and methods for combining mail pieces that were going to be mailed on different dates described in commonly-owned, co-pending U.S. patent application Ser. No. 12/028,386, entitled “Method For Combining Mail Pieces That Were Going To Be Mailed On Different Dates To Increase Postal Discounts,” filed Feb. 8, 2008, by Winkelman, et al., which is incorporated herein by reference in its entirety. For example, in an alternative applicable to any of the embodiments herein, the systems and methods therein may be used to combine multiple direct mail campaigns such that postal discounts are optimized if delivery dates relevant to the mailing campaigns permit such combination. In yet further alternatives, the “cycle date” systems of application Ser. No. 12/028,386 are utilized with the standby mail piece systems herein. For example, if standby mail pieces are available for certain sub-mailings in a mailing campaign (such as by zip code), then the cycle dates of the original or underlying mailing are not modified. For sub-mailings without sufficient standby mail pieces available to optimize postage discounts, then the cycle dates are modified for those zip codes.

In further alternative embodiments, the embodiments described herein may additionally and/or alternatively utilize the systems and methods for combining mail pieces that were going to be mailed on different dates described in commonly-owned, co-pending U.S. patent applications Ser. No. 11/373,557, entitled “Method For Predicting when Mail is Received by a Recipient,” filed Mar. 10, 2006 by Roj as, et al., U.S. Ser. No. 11/373,562, entitled “Method for Dynamically Controlling Call Center Volumes,” filed Mar. 10, 2006 by Tsipenyuk, et al., U.S. Ser. No. 11/372,809 entitled “Method for Controlling When Mail is Received by a Recipient.” filed Mar. 10, 2006 by Norris, Jr., et al. and U.S. Ser. No. 11/450,533 entitled “Intelligent Mail System to Coordinate Direct Mail with other Marketing Channels Using Mail Prediction and Mail Control,” filed Jun. 9, 2006 by Rojas, et a., which are all incorporated herein by reference in their entirety. For example, in an alternative applicable to any of the embodiments herein, the mail prediction system described therein may provide data used to determine whether to delay induction of a mail piece de to a weather forecast.

While several embodiments of the invention have been described and illustrated above, it should be understood that these are exemplary of the invention and are not to be considered as limiting. Additions, deletions, substitutions, and other modifications can be made without departing from the spirit or scope of the present invention. For example, other known challenge/response information architectures may be substituted for those described above. Accordingly, the invention is not to be considered as limited by the foregoing description but is only limited by the scope of the appended claims.

What is claimed is:

1. A method for creating a direct mail advertising campaign targeted mailing list comprising:
prompting an advertiser for targeted mail campaign information;
receiving targeted mail campaign information from the advertiser;
providing a graphical representation of potential targeted regions each having a potential opportunity indication;
receiving selection information from the user interacting with the graphical representation; and
creating the direct mail advertising campaign targeted mailing list using the selection information.

2. The method of claim 1 further comprising:
determining an alternative targeted mail campaign information to optimize postage costs; and
providing the alternative targeted mail campaign information to the advertiser.

3. The method of claim 2 wherein,
the alternative targeted mail campaign information includes a direct mail piece up-sell offer based upon optimized postage costs.

4. The method of claim 3 wherein,
the direct mail piece up-sell offer is provided graphically by zip code.

5. The method of claim 3 wherein,
the direct mail piece up-sell offer is provided on a rolling basis over multiple primary mailings.

6. The method of claim 1 wherein,
the direct mail advertising campaign targeted mailing list is created using the selection information and profile data selected from the group consisting of aggregated block group targeting data and individual profile data.

7. The method of claim 1 wherein,
the direct mail advertising campaign comprises a primary direct mail advertising campaign and a secondary direct mail advertising campaign.

8. The method of claim 7 wherein,
the primary direct mail advertising campaign comprises a current customer list and the secondary direct mail advertising campaign comprises a targeted mailing list is created using the selection information and profile data selected from the group consisting of aggregated block group targeting data and individual profile data.

9. A method for optimizing postage costs in a direct mail campaign comprising:
obtaining a standby direct mail campaign having an associated tracking database;
receiving a primary mailing;
determining a number of standby mail pieces required to optimize postage costs associated with the primary mailing;
adding the required number of standby mail pieces to the primary mailing; and
updating the tracking database to reflect the standby mail pieces used.

10. The method of claim 9 further comprising:
utilizing a plurality of standby direct mail campaigns to optimize postage costs associated with a primary mailing.

11. The method of claim 10 wherein the primary mailing comprises sub-mailings by geography, further comprising:
determining an appropriate one of the plurality of standby direct mail campaigns to optimize postage costs associated with each sub-mailing in the primary mailing using targeted marketing criteria.

12. The method of claim 10 wherein the primary mailing comprises sub-mailings by day, further comprising:
determining an appropriate one of the plurality of standby direct mail campaigns to optimize postage costs associated with each sub-mailing in the primary mailing using date availability.

13. The method of claim 12 further comprising:
determining if the appropriate one of the standby direct mail campaigns is expired; and
if expired, adding any remaining mail pieces in the appropriate one of the standby direct mail campaigns on the expiration day.

14. The method of claim 10 wherein,
at least two of the plurality of standby direct mail campaigns are associated with at least two distinct respective standby advertisers.

15. The method of claim 9 further comprising:
customizing the standby mail pieces when used.

16. A method for determining when to induct a mail piece comprising:
obtaining a mail campaign profile comprising at least one environmental data related induction parameter associated with at least one environmental parameter for the mail campaign;
obtaining an environmental data forecast;
determining whether the at lease one environmental data related induction decision is applicable for the mail piece using the campaign profile and the environmental data forecast; and
inducting the mail piece in accordance with the determination.

17. The method of claim 16 wherein,
the environmental data comprises weather data and the environmental data forecast comprises a weather forecast.

18. The method of claim 17, wherein the mail piece is a direct mail piece and the at least one environmental parameter is a preferred delivery date.

19. The method of claim 18 further comprising:
customizing the direct mail piece based upon the weather forecast.

20. The method of claim 16 wherein the mail piece comprises a mail campaign having at least two sub-mailings each associated with a distinct destination zip code and the environmental forecast includes a sub-forecast obtained for each distinct destination zip code, further comprising:
separately determining for each sub-mailing whether the at lease one environmental data related induction decision is applicable for each of the plurality of mail pieces using the campaign profile and the sub-forecast.
